(19) United States
(12) Patent Application Publication
(10) Pub. No.: US 2019/0315169 A1
(43) Pub. Date: Oct. 17, 2019

(54) INDICATOR APPARATUS AND RELATED METHODS FOR USE WITH VEHICLES

(71) Applicant: Ford Global Technologies, LLC, Dearborn, MI (US)

(72) Inventors: Anton Rogness, Dearborn, MI (US); Andrew Niedert, Farmington Hills, MI (US); Elliott Pearson, Shelby Township, MI (US); Joshua Rajasingh, Ypsilanti, MI (US)

(21) Appl. No.: 15/955,437

(22) Filed: Apr. 17, 2018

(51) Int. Cl. B60D 1/24; G01G 19/12; B60D 1/62; B60D 1/36

(52) U.S. Cl. CPC B60D 1/248; B60D 1/247; B60D 1/06; B60D 1/62; B60D 1/36; G01G 19/12

(57) ABSTRACT

Indicator apparatus and related methods for use with vehicles are disclosed. An example apparatus includes a controller configured to determine a load imparted on a hitch via a sensor. The hitch is to be coupled between a vehicle and a trailer. The controller is also configured to compare the load to a threshold load. The threshold load is based on a weight of the trailer. The controller is also configured to control an exterior light of the vehicle based on the comparison to visually indicate a load status of the trailer.

### FIELD OF THE DISCLOSURE

This disclosure relates generally to vehicles and, more particularly, to indicator apparatus and related methods for use with vehicles.

### BACKGROUND

Some vehicles include a hitch for towing. To ensure proper vehicle handling and/or performance when towing a trailer, the trailer is loaded such that a force imparted on the hitch corresponds to a certain proportion of the trailer weight. Typically, when a driver is loading the trailer, another person (sometimes referred to as a spotter) monitors the hitch and/or the force imparted thereon to inform the driver when the trailer is properly loaded.

Some vehicles such as trucks, sport utility vehicles (SUVs), etc. can carry significant weight and are associated with particular weight limits that should not be exceeded. As such, to ensure proper vehicle handling and/or performance during normal use, a vehicle is loaded such that cargo, freight, etc. carried thereby does not exceed a weight limit thereof. Sometimes, a spotter may assist a driver in loading the vehicle by monitoring the vehicle weight and conveying the same to the driver.

### SUMMARY

An example apparatus includes a controller configured to determine a weight of a vehicle via a sensor. The controller is also configured to compare the weight to a threshold weight. The threshold weight is based on a capacity of the vehicle. The controller is also configured to control an exterior light of the vehicle based on the comparison to visually indicate a load status of the vehicle.

Another example apparatus includes a controller configured to determine a load imparted on a hitch via a sensor. The hitch is to be coupled between a vehicle and a trailer. The controller is also configured to compare the load to a threshold load. The threshold load is based on a weight of the trailer. The controller is also configured to control an exterior light of the vehicle based on the comparison to visually indicate a load status of the trailer.

Another example apparatus includes a controller configured to determine, via a sensor, a load associated with a vehicle during a loading event. The controller is also configured to compare the load to a threshold load. The controller is also configured to control an external light or a horn of the vehicle based on the comparison to indicate a status of the vehicle.

Another example apparatus includes a controller configured to determine, via a sensor, a parameter associated with a vehicle. The controller is also configured to compare the parameter to a threshold parameter. The controller is also configured to control an exterior light of the vehicle based on the comparison to indicate a status of the vehicle.

### BRIEF DESCRIPTION OF THE DRAWINGS

FIG. 1 is a view of an example vehicle in which examples disclosed herein may be implemented.

FIG. 2 is a view of an example light in accordance with examples disclosed herein.

FIG. 3 is a block diagram of an example indicator system in accordance with the teachings of this disclosure.

FIG. 4A illustrates example trailer monitoring and light control that may be implemented in examples disclosed herein.

FIG. 4B is a detailed partial-view of the example vehicle of FIG. 1 showing an example hitch.

FIGS. 5A and 5B illustrate example vehicle monitoring and light control that may be implemented in examples disclosed herein.

FIGS. 6 and 7 are flow diagrams of example methods that may be executed to implement the example indicator system of FIG. 3.

FIG. 8 is a block diagram of an example processor platform structured to execute instructions to carry out the example methods of FIGS. 6 and 7 and/or, more generally, to implement the example indicator system of FIG. 3.

The figures are not to scale. In general, the same reference numbers will be used throughout the drawing(s) and accompanying written description to refer to the same or like parts.

### DETAILED DESCRIPTION

Some known vehicle monitoring systems monitor a load imparted on a vehicle hitch (sometimes referred to as tongue ball weight) by a trailer to inform a driver whether contents of the trailer are properly positioned thereon via a display of a smartphone or a display disposed in the vehicle. Other known vehicle monitoring systems monitor a weight of a vehicle and similarly inform, via the display(s), the driver whether the weight exceeds a weight limit of the vehicle. In this manner, the driver can load the trailer and/or the vehicle without assistance from another person. However, these known vehicle monitoring systems can impede the driver from properly loading the trailer and/or the vehicle by requiring the driver to frequently view a display.

Indicator apparatus and related methods for use with vehicles are disclosed. Examples disclosed herein assist a person (e.g., a driver, a passenger, vehicle servicer personnel, etc.) in properly loading a vehicle and/or a trailer associated therewith without aid from another person. Some disclosed examples provide an example vehicle controller (e.g., an electronic control unit (ECU)) communicatively coupled to an example light (e.g., a taillight, a headlight, a third brake light, side marker, etc.). In particular, the controller directs the light to generate predetermined visual indicators that inform the person when the trailer and/or the vehicle is properly loaded during a loading event. To determine a visual characteristic for the light, the example controller compares detected loads (e.g., loads corresponding to a tongue ball weight and/or a vehicle weight) associated with the vehicle to one or more example thresholds (e.g., values corresponding to a proportion of a trailer weight and/or a weight limit of the vehicle). Additionally, in some examples, the controller monitors loads for changes therein and, in response, changes or adjusts the visual characteristic of the light to facilitate load adjustments by the person.

In some disclosed examples, when loading the trailer, the controller determines an example load imparted on a hitch by a trailer tongue via one or more sensors (e.g., a load sensor operatively coupled to the hitch and/or a vehicle axle) and compares the load to an example threshold load (e.g., a predetermined and/or calculated value corresponding to a proportion (e.g., between about 10% and about 25%) of the trailer weight). Based on the comparison, the example controller generates, via the light, a predetermined visual indicator via to visually indicate to the person loading the trailer a load status (e.g., properly or improperly loaded) of the trailer and/or a degree to which weight of the trailer is improperly distributed.

In some examples, the controller enables the light to blink (i.e., activate and deactivate) at a predetermined rate or frequency based on a magnitude of the load relative to a magnitude of the threshold load. In such examples, the frequency at which the light blinks can visually indicate the degree to which the trailer is improperly loaded.

As the person positions and/or adjusts contents on the trailer, the example controller changes or adjusts a visual characteristic of the example light based on a change in the load imparted on the hitch, thereby visually informing the person of a change in the trailer load and/or a distribution thereof. In this manner, disclosed examples visually indicate to the person whether the weight distribution of the trailer is improving. For example, the controller increases or decreases the frequency at which the light blinks in response to changes in the load. Additionally, in some examples, the controller can cause the light to cease blinking (e.g., maintain brightness thereof or deactivate) in response to the load satisfying the threshold load, which may visually indicate that the trailer is properly loaded for towing by the vehicle.

In some examples, to similarly indicate when the trailer is properly loaded and/or the degree to which the trailer is improperly loaded, the controller generates one or more predetermined colors. For example, a first predetermined color (e.g., red) may visually indicate the load imparted on the hitch is far below the threshold load. In some examples, a second predetermined color (e.g., yellow) may visually indicate the load imparted on the hitch is proximate to the threshold load. In some examples, a third predetermined color (e.g., green) may visually indicate the load satisfies the threshold load (i.e., the trailer is properly loaded).

In such examples, as the person positions and/or adjusts the contents on the trailer, the controller enables the light to change between the predetermined colors in response to load changes. In particular, the controller can change the colors of the light in accordance with one or more predetermined color sequences (e.g., stored in a memory of the controller). For example, as the load approaches and satisfies the threshold load, the color of the light changes consecutively from red, to yellow, and then to green (i.e., a first example predetermined color sequence).

Further, some disclosed examples provide an example mobile device (e.g., a smartphone) communicatively coupled to the controller. In particular, the mobile device enables the person to remotely monitor the load imparted on the hitch when towing the trailer via the vehicle. More particularly, the controller directs the mobile device to generate a warning and/or a notification in response to the load not satisfying the threshold load (e.g., resulting from changes in trailer weight distribution).

In some disclosed examples, when loading the vehicle, the controller determines a weight of the vehicle via one or more sensors (e.g., a load sensor operatively coupled to a vehicle axle, a ride height sensor, etc.) and compares the weight to an example threshold weight (e.g., a predetermined value corresponding to a weight limit of the vehicle). Based on the comparison, the example controller generates a predetermined visual indicator via the light to visually indicate to the person loading the vehicle a load status of the vehicle (e.g., properly or improperly loaded) and/or a degree to which the vehicle is loaded below or above a weight limit thereof.

In some examples, the controller generates one or more of the example predetermined colors via the light based on a magnitude of the detected weight relative to a magnitude of the threshold weight. For example, the first predetermined color (e.g., red) may visually indicate that the vehicle weight is at or above the weight limit. In some examples, the second predetermined color (e.g., yellow) may visually indicate that the vehicle weight is proximate to the weight limit. In some examples, the third predetermined color (e.g., green) may visually indicate that the vehicle weight is sufficiently below the weight limit. Further, in some examples, the controller enables at least a portion of the example light to blink (e.g., at a predetermined frequency) in response to the vehicle weight significantly exceeding the weight limit.

As the person increases or decreases weight carried by the vehicle, the example controller changes or adjusts a visual characteristic of the example light based on a change in the vehicle weight, thereby visually informing the person of a change in the vehicle load and/or a distribution thereof. In some examples, the controller enables the example light to change between generating the predetermined colors in accordance with one or more predetermined color sequence (e.g., stored in a memory of the controller). For example, as the vehicle weight approaches and exceeds the threshold weight, the color of the light changes consecutively from green, to yellow, and then to red (i.e., a second example predetermined color sequence).

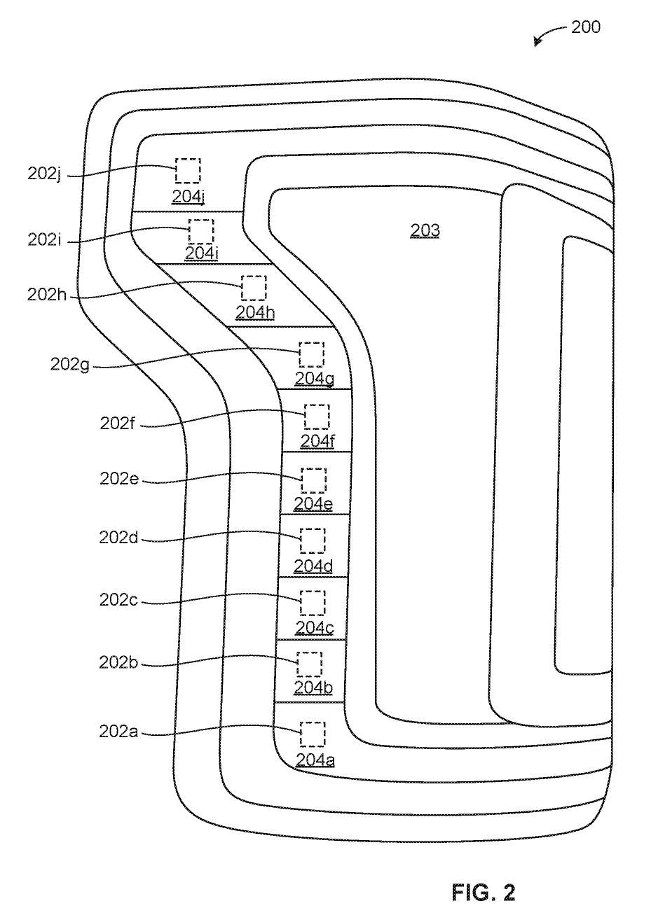

In some disclosed examples, as discussed in greater detail below in connection with FIG. 2, the example light is implemented with multiple lights sources (e.g., light-emitting diodes (LEDs), light bulbs, etc.) that form visual patterns, which facilitate visual inspection by the person when loading the trailer and/or the vehicle. In particular, the example controller generates a predetermined visual pattern via the light based on a magnitude of the vehicle weight relative to the magnitude of the threshold weight. Similarly, in some examples, the controller generates the predetermined visual pattern based on the magnitude of the load imparted on the hitch relative to the magnitude of the threshold load.

Further, in such examples, the example controller enables the light sources to change between predetermined visual patterns in response to load changes. In some examples, the controller consecutively powers or activates the light sources. Conversely, in some examples, the controller can consecutively deactivate the light sources. In some examples, the controller enables at least some of the light sources to blink.

Additionally or alternatively, some disclosed examples provide audible indicators to similarly assist the person in loading the trailer and/or the vehicle. In particular, the controller directs a sound source (e.g., a horn, a transducer (sometimes referred to as a chime), etc.) of the vehicle to generate a predetermined audible indicator to inform the person when the trailer and/or the vehicle is/are properly loaded. For example, the controller can generate, at a predetermined rate or frequency, sound via the sound source. Stated differently, the example controller can periodically activate and deactivate the sound source. Further, in such examples, the controller changes or adjusts an audible characteristic of the sound based on detected load or weight changes. For example, the controller increases or decreases the frequency at which the sound source generates sound. In some examples, the controller ceases activating and deactivating the sound source (e.g., maintains a volume thereof or deactivates) in connection with satisfaction of an example threshold.

In addition or alternatively to indicating the above disclosed statuses of the trailer and/or the vehicle to the person, some disclosed examples visually and/or audibly indicate one or more other statuses of the vehicle. In such examples, which will be discussed in greater detail below, the vehicle controller similarly controls the example light and/or the example sound source based on sensor data corresponding to one or more other detected and/or measured parameters (e.g., a temperature, a fluid pressure, a volume or sound intensity (e.g., a decibel), a position of a motor and/or an actuator (e.g., associated with a vehicle window), an electrical current, a voltage, etc.) associated with the vehicle to visually indicate the same to a person external to the vehicle.

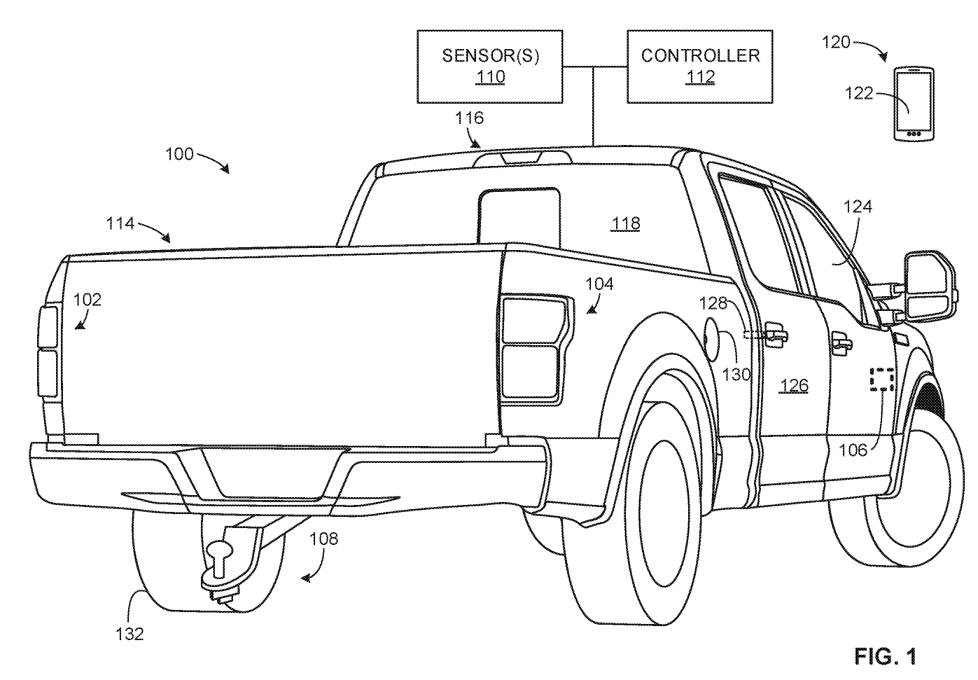

FIG. 1 is a view of an example vehicle (e.g., a truck, a sport utility vehicle (SUV), a car, etc.) 100 in which examples disclosed may be implemented. The example first vehicle 100 of FIG. 1 includes one or more example vehicle lights (e.g., headlights, taillights, etc.) 102, 104 (i.e., a first example vehicle light 102 and a second example vehicle light 104), an example horn 106, an example hitch 108, one or more example sensors 110, and an example vehicle controller 112.

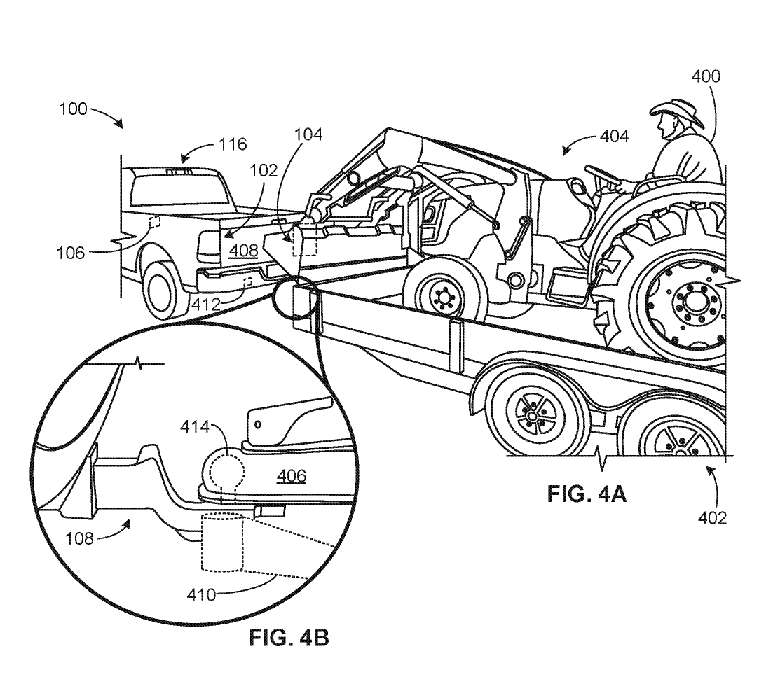

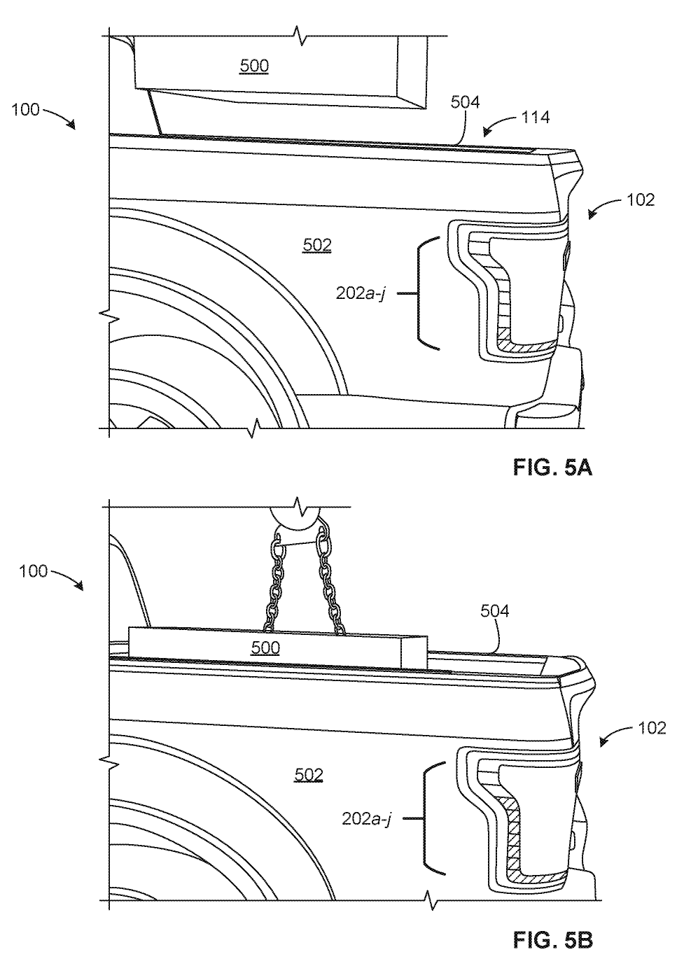

In some examples, to implement towing for the first vehicle 100, the example hitch 108 is coupled to the first vehicle 100. In particular, the hitch 108 of FIG. 1 is to receive and/or movably couple to at least a portion of a trailer (e.g., a trailer tongue), as discussed further below in connection with FIGS. 4A and 4B. While the example of FIG. 1 depicts the hitch 108 as being a drawbar hitch (sometimes referred to as a bumper pull hitch), in other examples, the first vehicle 100 may be implemented with any other suitable hitch such as, for example, a weight distributing hitch, a fifth wheel hitch, a gooseneck hitch, etc. Accordingly, in some examples, the hitch 108 may be disposed on a different portion of the first vehicle 100 such as in a vehicle bed 114.

As will be discussed in greater detail below in connection with FIGS. 2-8, the example controller 112 detects and/or monitors a load imparted on and/or associated with the hitch 108 via the sensor(s) 110 during a trailer loading event and, in response, controls one or more of the example lights 102, 104 to visually assist a person in loading a trailer associated with the first vehicle 100. Additionally or alternatively, in some examples, the example controller 112 detects and/or monitors a weight of the first vehicle 100 via the sensor(s) 110 during a vehicle loading event and, in response, controls one or more of the example lights 102, 104 to visually assist a person in loading the first vehicle 100. Further, in some examples, the controller 112 can similarly control the horn 106 and/or one or more other sound sources during a loading event to audibly assist a person.

In some examples, the example controller 112 detects and/or monitors one or more other parameters associated with the first vehicle 100 via the sensor(s) 110 in addition or alternatively to the hitch load and/or the vehicle weight, as discussed further below. In such examples, the controller 112 similarly controls one or more of the example lights 102, 104 based on data received from the sensor(s) 110.

The controller 112 of the illustrated example can be implemented, for example, using an electronic control unit (ECU). As such, the controller 112 of FIG. 1 is communicatively coupled to one or more of the lights 102, 104, the horn 106, and/or the sensor(s) 110, for example, via one or more signal transmission wires or busses, radio frequency, etc.

To measure and/or detect a load associated with first vehicle 100, the sensor(s) 110 of FIG. 1 can include, but is/are not limited to, a force or load sensor (e.g., operatively coupled to a vehicle axle and/or the hitch 108), a strain gauge (e.g., operatively coupled to a vehicle axle and/or the hitch 108), a ride height sensor, and/or a tire pressure sensor (e.g., associated with a tire pressure monitoring system (TPMS)). In some examples, the controller 112 detects, via the sensor(s) 110, one or more loads corresponding to a tongue ball weight. In some examples, the controller 112 detects, via the sensor(s) 110, one or more loads corresponding to a weight of the first vehicle 100. Further, in some examples, to enable the controller 112 to measure and/or detect one or more other vehicle parameters, the sensor(s) 110 of FIG. 1 can include, but is/are not limited to, a temperature sensor, a current sensor, a voltage sensor, a potentiometer, an optical sensor (e.g., a camera), and/or a distance or proximity sensor (e.g., an ultrasonic sensor, an infrared sensor, etc.).

While the example of FIG. 1, depicts the first example light 102 and the second example light 104 as being taillights, in other examples, the first light 102 and/or the second light 104 may correspond to a different external light of the first vehicle 100 to provide a visual indication to a person external to the first vehicle 100 such as, for example, a headlight, a side marker, etc. For example, as shown in the illustrated example of FIG. 1, the controller 112 can communicate with and/or control an example third vehicle light 116 (sometimes referred to as a third brake light), which is disposed proximate an example windshield (e.g., a rear windshield) 118 of the first vehicle 100 in this example

Further, in some examples, the controller 112 controls one or more lights that are separate from components of the first vehicle 100 such as, for example, multiple light-emitting diodes disposed externally relative to the first vehicle 100. Thus, examples disclosed herein may be implemented using one or more of the lights 102, 104, 116 of the first vehicle 100 and/or one or more lights separate from the first vehicle 100.

In some examples, to enable a person to monitor remotely a status of the first vehicle 100 and/or a trailer associated therewith, the example controller 112 communicates with a mobile device 120 such as, for example, a smartphone. In particular, the mobile device 120 of the illustrated example includes a screen or display 122 to generate images for viewing by a user and/or a speaker or transducer to generate sound. The example mobile device 120 also includes one or more input devices (e.g., a touch screen, a keyboard, a microphone, etc.) to receive user input and/or data.

Additionally or alternatively, in some examples, the controller 112 enables the light(s) 102, 104, 116 to visually indicate one or more other statuses of the first vehicle 100, which may aid a person outside of the vehicle 100. In some examples, the controller 112 enables the light(s) 102, 104, 116 to visually indicate whether an example window (e.g., a passenger and/or a driver window) 124 of the first vehicle 100 is open, closed, and/or a degree to which the window 124 is open. In some examples, the controller 112 enables the light(s) 102, 104, 116 to visually indicate whether an example door (e.g., a passenger and/or a driver door) 126 of the first vehicle 100 is open or closed. In some examples, the controller 112 enables the light(s) 102, 104, 116 to visually indicate whether an example lock (e.g., an electronic or power door lock) 128 operatively coupled to the door 126 is locked or unlocked. In some examples, the controller 112 enables the light(s) 102, 104, 116 to visually indicate whether a fuel door 130 of the first vehicle 100 is open or closed. In some examples, the controller 112 enables the light(s) 102, 104, 116 to visually indicate whether a fuel tank of the first vehicle 100 is properly filled and/or a degree to which the fuel tank is filled. In some examples, the controller 112 enables the light(s) 102, 104, 116 to visually indicate whether an example tire (e.g., a left and/or a rear tire) 132 of the first vehicle 100 is properly filled or inflated and/or a degree to which the tire 132 is inflated. In some examples, the controller 112 enables the light(s) 102, 104, 116 to visually indicate an electrical power level of a battery (e.g., a 12-volt battery) of the first vehicle 100. In some examples, the controller 112 enables the light(s) 102, 104, 116 to visually indicate an electrical power level of a generator of the vehicle. In some examples, the controller 112 enables the light(s) 102, 104, 116 to visually indicate a temperature of an engine of the first vehicle 100. In some examples, the controller 112 enables the light(s) 102, 104, 116 to visually indicate a temperature of a fluid (e.g., oil) in the engine. In some examples, the controller 112 enables the light(s) 102, 104, 116 to visually indicate a temperature of another fluid (e.g., air) in a cabin of the first vehicle 100.

In some such examples, the controller 112 implements control of the light(s) 102, 104, 116 in response to user input to, for example, the example mobile device 120, an electronic device disposed in the first vehicle 100, one or more buttons and/or switches disposed in the first vehicle 100, an electronic key fob communicatively coupled to the controller 112, etc. For example, a person activates or initiates a setting of the controller 112 and/or the first vehicle 100, thereby enabling the controller 112 to detect and/or monitor (e.g., continuously or repeatedly) the one or more parameters associated with the first vehicle 100 and/or control the light(s) 102, 104, 116.

FIG. 2 is a detailed view of an example fourth light 200 in accordance with examples disclosed herein. In some examples, the example fourth light 200 of the illustrated example corresponds to one or more lights of the aforementioned first vehicle 100 of FIG. 1 such as, for example, the example first light 102, the example second light 104, and/or the example third light 116. According to the illustrated example of FIG. 2, the fourth light 200 includes multiple light-emitting diodes (LEDs) 202a-j, ten of which are shown in this example. In this example, the LEDs 202a-j are disposed behind a lens 203 of the light 200. In particular, the LEDs 202a-j of the illustrated example illuminate different portions or areas 204a-j of the fourth light 200, thereby forming a visual pattern to facilitate visual inspection of the fourth light 200 by a person.

As shown in FIG. 2, the LEDs 202a-j of the illustrated example extend along a substantially vertical direction. However, in other examples, the LEDs 202a-j may have any other suitable orientation. For example, the LEDs 202a-j may extend along a substantially horizontal direction and/or a curved path. Further, while the example LEDs 202a-j of FIG. 2 form a substantially rectangular array (e.g., having one column and ten rows), in other examples, the LEDs a-j may form an array that is larger, smaller, and/or shaped differently.

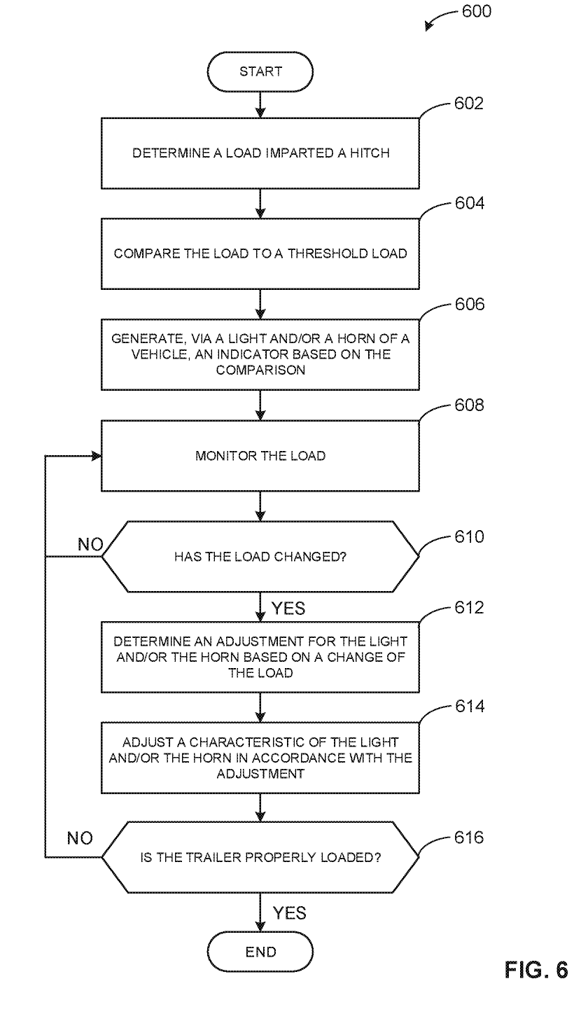

In some examples, the visual pattern formed by the LEDs 202a-j is predetermined and/or changes, for example, based on commands and/or power provided from the aforementioned controller 112. In such examples, the controller 112 can change or adjust one or more visual characteristics of the pattern (e.g., in response to parameter changes measured by the example sensor(s) 110), as discussed further below in connection with FIGS. 4A, 4B, 5A, and 5B. For example, the controller 112 enables at least some of the LEDs 202a-j to blink (i.e., activate and deactivate). In some examples, the controller 112 enables at least some of the LEDs 202a-j to change color and/or intensity or brightness. In some examples, the controller 112 consecutively activates and/or deactivates the LEDs 202a-j in accordance with one or more predetermined sequences (e.g., stored in a memory of the controller 112). While the example of FIG. 2 depicts the example fourth light 200 as being implemented with the LEDs 202a-j, in other examples, the fourth light 200 may be implemented using one or more other suitable light sources (e.g., one or more incandescent lights, fluorescent lights, etc.). Further, in some examples, the example LEDs 202 may be disposed on the first vehicle 100 (e.g., on an exterior surface of the first vehicle 100, behind the windshield 118, etc.).

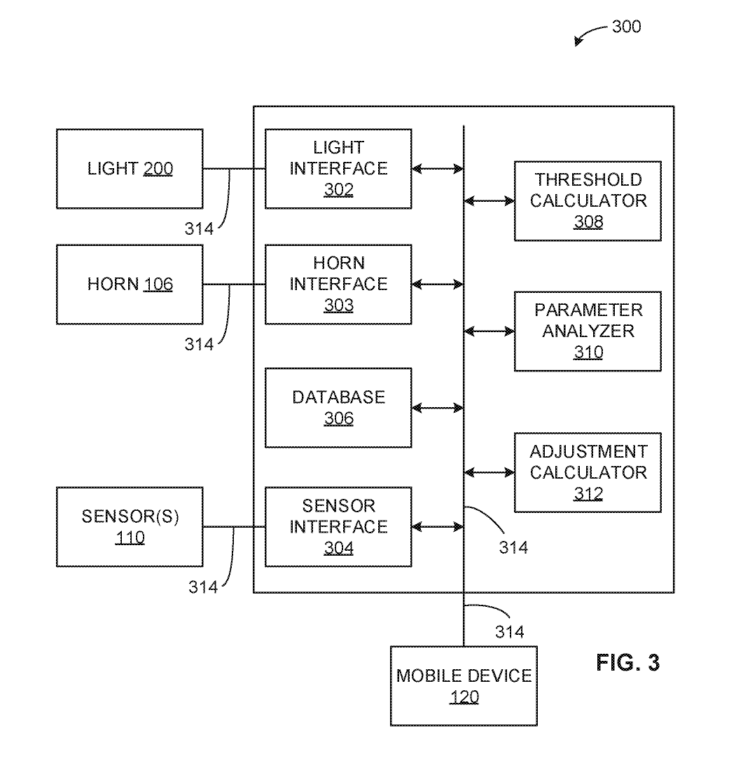

FIG. 3 is a block diagram of an example indicator system 300 in accordance with the teachings of this disclosure. The example indicator system 300 of FIG. 3 can be implemented by the example controller 112 of FIG. 1. The example indicator system 300 of FIG. 3 includes a light interface 302, a horn interface 303, a sensor interface 304, a database 306, a threshold calculator 308, a parameter analyzer 310, and an adjustment calculator 312. In the example of FIG. 3, the vehicle indicator system 300 is communicatively coupled to the example mobile device 120 of FIG. 1, the sensor(s) 110 of FIG. 1, the horn 106 of FIG. 1, and the example fourth light 200 disclosed above in connection with FIG. 2 via communication link(s) 314 such as, for example, one or more signal transmission wires or busses, radio frequency, etc. In particular, the example light interface 302 provides control or command signals and/or power to the fourth light 200 to generate light and/or illuminate one or more of the portions 204a-j thereof. Similarly, in some examples the example horn interface 303 provides control or command signals and/or power to the horn 106 to generate sound.

In some examples, to assist a person in loading a vehicle and/or a trailer, the example indicator system 300 directs the example fourth light 200 to control light generated thereby. Additionally or alternatively, in some examples, the example indicator system 300 directs the example horn 106 and/or one or more other sound sources to control sound generated thereby. In particular, during a loading event, the indicator system 300 of the illustrated example generates one or more predetermined visual indicators via the fourth light 200 and/or one or more predetermined audible indicators via the horn 106 based on sensor data corresponding to a load associated with the first vehicle 100. Further, in some examples, the indicator system 300 similarly controls the fourth light 200 based on sensor data corresponding to one or more other parameters associated with the first vehicle 100 to visually indicate the same to a person external to the first vehicle 100.

In some examples, the indicator system 300 enables the fourth light 200 to blink (i.e., activate and deactivate) at predetermined rates or frequencies (e.g., 1 hertz, 5 hertz, 10 hertz, etc.), generate predetermined colors (e.g., red, yellow, green, etc.), generate light having a predetermined brightness (e.g., 50 lumens, 200 lumens, 500 lumens, etc. In some examples, the indicator system 300 enables the horn 106 to activate and deactivate at predetermined rates or frequencies, generate sound having a predetermined pitch (e.g., 200 hertz, 1,000 hertz, 5,000 hertz, etc.), generate sound at a predetermined volume (e.g., 50 decibels, 75 decibels, 90 decibels, etc.), etc.

Further, in some examples, the predetermined visual indicator includes a visual pattern. For example, the indicator system 300 enables the fourth light 200 to generate one or more predetermined patterns (e.g., stored in the database 306) via the aforementioned LEDs 202a-j based on sensor data. Accordingly, the example light interface 302 of FIG. 3 is communicatively and/or operatively coupled to the fourth light 200 via the communication link(s) 314, and the example horn interface 303 is communicatively and/or operatively coupled to the horn 106 via the communication link(s) 314.

In the illustrated example of FIG. 3, the sensor interface 304 is communicatively coupled to the example sensor(s) 110 via the communication link(s) 314 to receive data therefrom. In some examples, the sensor(s) 110 generate data corresponding to a load associated with the hitch 108 and/or a change in the load and provide the data to the sensor interface 304. In some examples, the sensor(s) 110 generate data corresponding to a weight and/or a change in the weight of the first vehicle 100 and provide the data to the sensor interface 304. In some examples, the sensor(s) 110 generate data corresponding to one or more other parameters (e.g., a temperature, a fluid pressure, a sound intensity (e.g., a decibel), a position of a motor and/or an actuator (e.g., associated with a vehicle window), an electrical current, a voltage, etc.) associated with the first vehicle 100.

To determine whether to adjust one or more characteristics of the fourth light 200 and/or the horn 106 (e.g., during a loading event), the parameter analyzer 310 analyzes data received from one or more of the sensor interface 304, the database 306, and/or the threshold calculator 308. In particular, the parameter analyzer 310 analyzes the parameter(s) associated with the first vehicle 100 and/or performs one or more comparisons of the parameter(s) to one or more thresholds (e.g., calculated and/or determined via the threshold calculator 308), for example, to determine whether an example threshold is satisfied, whether a threshold is exceeded, a degree to which a threshold is exceeded, etc.

In some examples, based on a value or magnitude of a parameter relative to a value or magnitude of an example threshold, the parameter analyzer 310 enables the adjustment calculator 312 to calculate and/or determine one or more adjustments for the fourth light 200 and/or the horn 106. In some examples, based on a change in the parameter, the parameter analyzer 310 similarly enables the adjustment calculator 312 to calculate and/or determine one or more adjustments for the fourth light 200 and/or the horn 106. As such, the parameter analyzer 310 may transmit (e.g., via the wired and/or wireless communication link(s) 314) computed data to the adjustment calculator 312 and/or the database 306.

In the example of FIG. 3, the threshold calculator 308 calculates and/or determines one or more thresholds for the example parameter analyzer 310 based on data received from the mobile device 120 and/or the database 306. In some examples, the threshold calculator 308 calculates and/or determines one or more threshold loads based on a trailer weight (e.g., a combined weight of a trailer as well as contents carried thereby). In such examples, an example threshold load corresponds to a proportion (e.g., between about 10% and about 25%) of the trailer weight. The trailer weight may be stored in the database 306 and/or provided to the example indicator system 300 by a user, for example, via the mobile device 120. In other examples, the trailer weight may be provided to the example indicator system 300 via one or more other suitable input devices such as, for example, an electronic device that is disposed in the first vehicle 100 and communicatively coupled to the indicator system 300 (e.g., via the communication link(s) 314).

In some examples, the threshold calculator 308 calculates and/or determines one or more threshold weights based on a capacity or weight limit (e.g., a front axle weight limit, a rear axle weight limit, a gross vehicle weight limit, etc.) associated with the example first vehicle 100. In such examples, an example threshold weight corresponds to one or more proportions (e.g., 80%, 90%, 100%, 110%, etc.) of the weight limit. The weight capacity of the first vehicle 100 may be stored in the database 306 and/or provided to the example indicator system 300 by a user (e.g., via the mobile device 120, an electronic device disposed in the first vehicle 100, etc.).

Further, in some examples, the threshold calculator 308 similarly calculates and/or determines one or more other thresholds (e.g., a threshold temperature, a threshold pressure, a threshold position, a threshold power, a threshold sound intensity, etc.) that facilitate control of the example fourth light 200 by the indicator system 300. For example, the threshold calculator 308 calculates and/or determines a threshold axle load corresponding to a certain proportion (e.g., about 25%) of a load imparted on an axle (e.g., a front axle) of the first vehicle 100, which can enable the indicator system 300 to visually assist a person in configuring a load distributing hitch. That is, in such examples, the threshold axle load is based on an axle load provided by the first vehicle 100 being stationary without a trailer coupled thereto. In some examples, the threshold calculator 308 calculates and/or determines an example threshold temperature corresponding to one or more of an engine temperature, an oil temperature, and/or a cabin temperature that may be desired by a person. In some examples, the threshold calculator 308 calculates and/or determines an example threshold fluid pressure corresponding to a certain tire pressure (e.g., 30 pounds per square inch (PSI), 35 PSI, 40 PSI, etc.) of the first vehicle 100 and/or a fuel tank pressure of the first vehicle 100. In some examples, the threshold calculator 308 calculates and/or determines an example threshold distance corresponding to a position of a trailer tongue relative to a hitch and/or a ball. In another example, the threshold calculator 308 calculates and/or determines an example threshold electrical current, an example threshold voltage, and/or an example threshold power associated with the battery and/or the generator of the first vehicle 100.

In the example of FIG. 3, the example adjustment calculator 312 performs one or more calculations associated with controlling the example fourth light 200 (e.g., controlling one or more of the example LEDs 202a-j) and/or the example horn 106. As such, in some examples, the adjustment calculator 312 transmits (e.g., via the wired and/or wireless communication link(s) 314) computed data to the database 306 and/or the light interface 302. In particular, the example adjustment calculator 312 calculates and/or determines adjustments of the visual characteristic(s) of the fourth light 200 and/or the audible characteristic(s) of the horn 106 based on the analyses and/or the comparisons performed by the parameter analyzer 310.

In some examples, when controlling the fourth light 200, an example adjustment includes increasing or decreasing an intensity or brightness of the fourth light 200. In some examples, an example adjustment includes changing a color generated by the fourth light 200. In some examples, an example adjustment includes increasing or decreasing a frequency at which the fourth light 200 blinks.

Further, in examples where the first vehicle 100 is implemented with the example LEDs 202a-j, an example adjustment includes changing between predetermined visual patterns. For example, an example adjustment includes activating, deactivating, and/or changing a color of some of the LEDs 202a-j (e.g., while maintaining visual characteristic(s) of the other ones of the LEDs 202a-j).

In some examples, when controlling the horn 106, an example adjustment includes increasing or decreasing an intensity or volume of the horn 106. In some examples, an example adjustment includes increasing or decreasing a pitch of the horn 106. In some examples, an example adjustment includes increasing or decreasing a frequency at which the horn 106 is repeatedly activated and deactivated.

After determining one or more adjustments for the fourth light 200, the adjustment calculator 312 transmits (e.g., via the wired and/or wireless communication link(s) 314) the adjustment(s) to the light interface 302 to control the fourth light 200 accordingly. In particular, the example light interface 302 directs the fourth light 200 to change or adjust one or more of the visual characteristics thereof in accordance with the calculated adjustment(s) to visually communicate to a person external to the first vehicle 100.

Similarly, in some examples, after determining one or more adjustments for the horn 106, the adjustment calculator 312 transmits (e.g., via the wired and/or wireless communication link(s) 314) the adjustment(s) to the horn interface 303 to control the horn 106 accordingly. In particular, the example horn interface 303 directs the horn 106 to change or adjust one or more of the audible characteristics thereof in accordance with the calculated adjustment(s) to audibly communicate to a person external to the first vehicle 100.

The database 306 of the illustrated example stores and/or provides access to data associated with the example first vehicle 100 of FIG. 1, the example fourth light 200 of FIG. 2, and/or the example indicator system 300. For example, the example database 306 receives data from and/or transmits data to (e.g., via the wired and/or wireless communication link(s) 314) one or more of the light interface 302, the sensor interface 304, the threshold calculator 308, the parameter analyzer 310, and/or the adjustment calculator 312. Additionally or alternatively, the database 306 stores sensor data generated by the sensor(s) 110.

In some examples, the database 306 stores one or more predetermined visual and/or audible characteristics associated with controlling the fourth light 200 and/or the horn 106. In some examples, the database 306 stores one or more predetermined frequencies (e.g., 1 hertz, 5 hertz, 10 hertz, etc.). In some examples, the database 306 stores one or more predetermined colors (e.g., green, yellow, red, etc.).

In examples where the first vehicle 100 is implemented with the LEDs 202a-j (and/or one or more other light sources), the database 306 stores one or more predetermined visual patterns to be generated by the LEDs 202a-j. For example, a first example predetermined visual pattern includes some of the LEDs 202a-j being activated while the other of the LEDs 202a-j are deactivated. In some examples, a second example predetermined visual pattern includes all of the LEDs 202a-j being activated. In some examples, a third example predetermined visual pattern includes at least some of the LEDs 202a-j having a single color. In some examples, a fourth example predetermined visual pattern includes at least some of the LEDs 202a-j having different colors relative to each other. While some example visual patterns are disclosed herein in connection with the example LEDs 202a-j, in other examples, the indicator system 300 may control the LEDs 202a-j to provide one or more other visual patterns.

In some examples, the database 306 stores one or more predetermined sequences for controlling the example fourth light 200. For example, the database 306 stores one or more predetermined color sequences for the fourth light 200. In some examples, a first example predetermined color sequence includes consecutively changing the color of the fourth light 200 from red, to yellow, and then to green. Conversely, in some examples, a second example predetermined color sequence includes consecutively changing the color of the fourth light 200 from green, to yellow, and then to red. While some example color sequences have been disclosed herein, in other examples, one or more other color sequences may be implemented when controlling the fourth light 200.

The mobile device 120 of the illustrated example facilitates user interaction with and/or input to the indicator system 300. For example, a person may provide data (e.g., a trailer weight, a vehicle weight limit, a fuel level, a cabin temperature, an oil temperature, a battery power level, a generator power level, etc.) and/or view data (e.g., a measured parameter) via the mobile device 120 (e.g., before, during, and/or after a loading event). As such, the mobile device 120 of FIG. 3 is communicatively coupled to the indicator system 300 via the communication link(s) 314. However, in other examples, the indicator system 300 may be communicatively coupled to one or more other suitable user devices (e.g., an electronic device disposed in the first vehicle 100) to provide and/or facilitate user interaction and/or input.

While an example manner of implementing the example indicator system 300 is illustrated in FIG. 3, one or more of the elements, processes and/or devices illustrated in FIG. 3 may be combined, divided, re-arranged, omitted, eliminated and/or implemented in any other way. Further, the example light interface 302, the example horn interface 303, the example sensor interface 304, the example database 306, the example threshold calculator 308, the example parameter analyzer 310, the example adjustment calculator 312 and/or, more generally, the example indicator system 300 of FIG. 3 may be implemented by hardware, software, firmware and/or any combination of hardware, software and/or firmware. Thus, for example, any of the example light interface 302, the example horn interface 303, the example sensor interface 304, the example database 306, the example threshold calculator 308, the example parameter analyzer 310, the example adjustment calculator 312 and/or, more generally, the example indicator system 300 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example light interface 302, the example horn interface 303, the example sensor interface 304, the example database 306, the example threshold calculator 308, the example parameter analyzer 310, the example adjustment calculator 312 and/or, more generally, the example indicator system 300 of FIG. 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example indicator system 300 of FIG. 3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 4A illustrates example trailer monitoring and light control that may be implemented in examples disclosed herein. According to the illustrated example of FIG. 4A, a person (e.g., a driver, a passenger, a vehicle servicer, etc.) 400 is loading an example trailer 402 with an example second vehicle (e.g., a tractor) 404 (e.g., without assistance from another person). The trailer 402 of the illustrated example is movably and/or operatively coupled to the first vehicle 100 via the example hitch 108 (FIG. 4B) interposed therebetween. In particular, to ensure proper performance and/or handling of the example first vehicle 100 during use, the person 400 is positioning the second vehicle 404 on the trailer 402 such that a tongue 406 (FIG. 4B) of the trailer 402 imparts a certain force or load (sometimes referred to as tongue ball weight) on a ball of the hitch 108, which ensures proper vehicle handling and/or maneuverability when driving.

While the example of FIG. 4A depicts the example trailer 402 as being a bumper pull trailer, in other examples, the first vehicle 100 may be associated with and/or tow one or more other suitable trailers such as, for example, a gooseneck trailer. In such examples, as previously mentioned, the example vehicle 100 may be implemented with a gooseneck hitch and/or a fifth wheel instead of the example hitch 108 of the illustrated example. Further, in some example, the example trailer 402 receives or carries cargo, equipment, one or more other vehicles, etc. in addition or alternatively to the example second vehicle 404.

To assist the person 400 in loading the trailer 402, the example indicator system 300 controls (e.g., via the light interface 302) one or more lights of the first vehicle 100 based on data received from the aforementioned sensor(s) 110 such as, for example, the example first light 102, the example second light 104, and/or the example third light 116. According to the illustrated example, one or more of the example lights 102, 104, 116 of the first vehicle 100 may correspond to the example fourth light 200, as previously mentioned. As shown in FIG. 4A, the example lights 102, 104, 116 are positioned at a back or rear portion 408 of the first vehicle 100 and/or face toward the person 400 to facilitate viewing while loading the trailer 402.

As previously disclosed, the indicator system 300 detects (e.g., via the sensor interface 304) the load imparted on the hitch 108 by the trailer tongue 406 and compares (e.g., via the parameter analyzer 310) the load to an example threshold load (e.g., a value corresponding to a proportion of a weight of the trailer 402). In the illustrated example of FIG. 4A, the indicator system 300 enables the light(s) 102, 104, 116 to generate a predetermined visual indicator based on a magnitude of the load imparted on the hitch 108 relative to a magnitude of the threshold load, which can visually indicate to the person 400 when the trailer 402 is properly loaded and/or a degree to which the trailer 402 is improperly loaded.

In some examples, the indicator system 300 enables the light(s) 102, 104, 116 to blink at a predetermined frequency. In such examples, a relatively low frequency (e.g., 1 hertz) may visually indicate to the person 400 that the load imparted on the hitch 108 is far below the threshold load and a relatively high frequency (e.g., 10 hertz) may visually indicate to the person 400 that the load imparted on the hitch 108 is proximate to the threshold load. Additionally or alternatively, in some examples, the indicator system 300 enables the light(s) 102, 104, 116 to generate one or more predetermined colors (e.g., stored in the database 306) to similarly provide visual indications to the person 400. For example, a first predetermined color (e.g., red) may visually indicate that the load imparted on the hitch 108 is far below the threshold load. In some examples, a second predetermined color (e.g., yellow) may visually indicate the load imparted on the hitch 108 is proximate to the threshold load. In some examples, the third predetermined color (e.g., green) may visually indicate that the load imparted on the hitch 108 is about equal to the threshold load (e.g., the vehicle 404 is properly positioned on the trailer 402).

As the person 400 adjusts a position of the second vehicle 404 relative to the trailer 402, the indicator system 300 monitors the load of the hitch 108 for changes therein and determines (e.g., via the adjustment calculator 312) adjustments for the light(s) 102, 104, 116 in response. In some examples, as the load approaches the threshold load, the indicator system 300 increases (or decreases) the frequency at which the light(s) 102, 104, 116 blink, which may visually indicate to the person 400 that weight distribution of the trailer 402 is improving. In some examples, the indicator system 300 ceases blinking (e.g., maintains an intensity of or deactivates) the light(s) 102, 104, 116 in response to the load satisfying the threshold load, which may visually indicate to the person 400 that the second vehicle 404 is properly positioned on the trailer 402.

In some examples, based on a change in the load, the indicator system 300 generates, via the light(s) 102, 104, 116, the predetermined colors in accordance with one or more of the aforementioned predetermined color sequences. For example, as the load approaches the threshold load, the indicator system 300 generates consecutively, via the light(s) 102, 104, 116: (1) the first predetermined color; (2) the second predetermined color; and (3) the third predetermined color, which may visually indicate the weight distribution of the trailer 402 is improving.

Additionally or alternatively, in some examples, similar to the visual indications, the indicator system 300 controls the example horn 106 to audibly indicate to the person 400 the load status of the trailer 402 and/or the degree to which the trailer 402 is improperly loaded. For example, the indicator system 300 enables the horn 106 to activate and deactivate at a predetermined frequency based on a magnitude of the load imparted on the hitch 108 relative to a magnitude of the threshold load. For example, a relatively low frequency (e.g., 1 hertz) may audibly indicate to the person 400 that the load imparted on the hitch 108 is far below the threshold load, and a relatively high frequency (e.g., 10 hertz) may audibly indicate to the person 400 that the load imparted on the hitch 108 is proximate to the threshold load.

In such examples, as the person 400 adjusts a position of the second vehicle 404 relative to the trailer 402, the indicator system 300 determines (e.g., via the adjustment calculator 312) adjustments for the horn 106 in response. For example, as the load approaches the threshold load, the indicator system 300 increases (or decreases) the frequency at which the horn generates sound, which may audibly indicate to the person 400 that weight distribution of the trailer 402 is improving. In some examples, the indicator system 300 ceases activating and deactivating (e.g., maintains a volume of or deactivates) the horn 106 in response to the load satisfying the threshold load, which may audibly indicate to the person 400 that the second vehicle 404 is properly positioned on the trailer 402.

In some examples, after properly loading the trailer 402, the indicator system 300 can further inform the person 400 of the trailer load status via the example mobile device 120, for example, if a position of second vehicle 404 relative to the trailer 402 changes during use of the first vehicle 100. In particular, the mobile device 120 may generate and/or display a warning to the person in response to indicator system 300 determining that the load imparted on the hitch 108 no longer satisfies the threshold load.

In some examples, the example hitch 108 is a weight distributing hitch having one or more arms 410 (FIG. 4B) (one of which is shown in this example) extending therefrom to carry out front axle load restoration for the vehicle 100. The arm(s) 410 of the illustrated example are adjustably coupled to at least a portion of the trailer 402 to generate a torque and apply the torque to the hitch 108 and the first vehicle 100. In particular, the person 400 increases or decreases the torque by adjusting one or more of chains, cables, brackets, etc. that couple the arm(s) 410 to the portion of the trailer 402, thereby increasing or decreasing a load imparted on a front axle of the first vehicle 100.

In such examples, the indicator system 300 detects (e.g., via the sensor interface 304) a load imparted on the front axle of the first vehicle 100 and compares (e.g., via the parameter analyzer 310) the axle load to an example threshold axle load. In particular, the threshold axle load corresponds to a certain proportion (e.g., about 25%) of a load imparted on the front axle of the first vehicle 100 when the trailer tongue 406 is decoupled or disengaged from the hitch 108. When the axle load is substantially equal to the threshold axle load, the arm(s) 410 and/or the hitch 108 are considered to be properly configured.

In such examples, to assist the person 400 in configuring the arm(s) 410 and/or the hitch 108, the indicator system 300 enables the light(s) 102, 104, 116 to generate a predetermined visual indicator based on a magnitude of the axle load relative to a magnitude of the threshold axle load. In this manner, the indicator system 300 visually indicates to the person 400 when the arm(s) 410 and/or the hitch 108 are properly configured and/or a degree to which the arm(s) 410 and/or the hitch 108 are improperly configured. As such, as the person 400 adjusts the torque generated by the arm(s) 410 of the hitch 108, the indicator system 300 monitors the load of the front axle for changes therein and determines (e.g., via the adjustment calculator 312) adjustments for the light(s) 102, 104, 116 in response to be implemented by the light(s) 102, 104, 116.

In some examples, when the first vehicle 100 is implemented with autonomous functionality, the indicator system 300 assists the person in coupling the trailer 402 to the first vehicle 100 during an autonomous vehicle event. In such examples, the indicators system 300 communicates with an example sensor (e.g., a camera, an infrared sensor, an ultrasonic sensor, etc.) 412, which is positioned on the rear portion 408 of the first vehicle 100 in this example. In particular, the indicator system 300 identifies, via the sensor 412, a relative position of at least a portion (e.g., a ball 414) of the hitch 108 as well as a relative position of at least a portion (e.g., the tongue 406) of the trailer 402. For example, the indicator system 300 analyzes and/or otherwise processes the data received from the sensor 412 to calculate and/or determine the positions based on one or more related equations, algorithms, and/or methods or techniques. Further, in some such examples, the indicator system 300 calculates and/or determines a distance between the portion of the hitch 108 and the portion of the trailer 402, which enables the indicator system 300 to control the light(s) 102, 104, 116 to visually indicate a proximity of the portion of the hitch 108 relative to the portion of the trailer 402.

In such examples, when the first vehicle 100 is autonomously maneuvering to reduce (e.g., minimize) the distance between the ball 414 and the tongue 406, the indicator system 300 controls the light(s) 102, 104, 116 to visually indicate the same to the person 400. In this manner, the person 400 is enabled to determine whether the first vehicle 100 is driving autonomously and/or a proximity of the ball 414 relative to the tongue 406.

FIGS. 5A and 5B illustrate example vehicle monitoring and light control that may be implemented in examples disclosed herein. According to the illustrated example of FIGS. 5A and 5B, the person 400 is loading the aforementioned vehicle 100 with an example object 500 (e.g., without assistance from another person). As shown in FIGS. 5A and 5B, the object 500 is being positioned in the bed 114 of the first example vehicle 100. In particular, to ensure proper performance and/or handling of the first vehicle 100 during use, the person 400 is loading the first vehicle 100 such that a weight of the first vehicle 100 (e.g., a weight corresponding to the object 500 and/or a combination of the object 500 and the first vehicle 100) remains below a capacity or weight limit (e.g., stored in the databased 306) associated with the first vehicle 100.

While the examples of FIGS. 5A and 5B depict the first vehicle 100 as being loaded with the object 500, in other examples, the first vehicle 100 may receive cargo, equipment, etc. in addition or alternatively to the object 500.

To assist the person 400 in loading the first vehicle 100, the example indicator system 300 controls (e.g., via the light interface 302) one or more lights of the first vehicle 100 based on data received from the aforementioned sensor(s) 110 such as, for example, the example first light 102, the example second light 104, and/or the example third light 116 of the first vehicle 100, one or more of which may correspond to the aforementioned fourth light 200 of FIG. 2. According to the illustrated example of FIGS. 5A and 5B, the example first light 102 is implemented with the aforementioned LEDs 202a-j of FIG. 2 such that the person 400 can view and/or inspect the LEDs 202a-j when positioning content(s) in the bed 114.

As previously disclosed, the indicator system 300 detects (e.g., via the sensor interface 304) a weight of the first vehicle 100 and compares (e.g., via the parameter analyzer 310) the weight to one or more example threshold weights (e.g., values corresponding to proportions (e.g., 80%, 90%, 100%, 110%, etc.) of the weight limit of the first vehicle 100). In the illustrated example of FIG. 5A, the indicator system 300 directs the fourth light 200 to generate a predetermined visual indicator based on a magnitude of the weight relative to a magnitude of the threshold weight, which can visually indicate to the person 400 when the first vehicle 100 is properly loaded and/or a degree to which the first vehicle 100 is loaded below or above the weight limit.

In some examples, the indicator system 300 enables the first light 102 to generate one or more predetermined colors (e.g., stored in the database 306). For example, the indicator system 300 generates, via the first light 102, the third predetermined color (e.g., green) in response to the weight of the first vehicle 100 being at or below a first example threshold weight (e.g., about 80% of the weight limit), which may visually indicate to the person 400 that the first vehicle 100 is loaded below the weight limit thereof. In some examples, the indicator system 300 generates, via the first light 102, the second predetermined color (e.g., yellow) in response to the weight being between the first threshold weight and a second example threshold weight (e.g., between about 90% and about 100% of the weight limit), which may visually indicate to the person 400 that the first vehicle 100 is loaded near the weight limit. In some examples, the indicator system 300 generates, via the first light 102, the first predetermined color (e.g., red) in response to the weight being between the second threshold weight and a third example threshold weight (e.g., about 110% of the weight limit), which may visually indicate to the person 400 that the first vehicle 100 is loaded over the weight limit thereof. In some examples, the indicator system 300 enables at least a portion (e.g., some of the LEDs 202a-j) of the first light 102 to blink at a predetermined frequency in response to the weight being at or above the third threshold weight.

Additionally or alternatively, in some examples, the indicator system 300 enables the first light 102 to blink at a predetermined frequency, which may visually indicate the status of the first vehicle 100. For example, a relatively low frequency (e.g., 1 hertz) may indicate the weight of the first vehicle 100 is far below the weight limit, and a relatively high frequency (e.g., 10 hertz) may indicate the weight of the first vehicle 100 is proximate to or at the weight limit. Further, in such examples, the indicator system 300 can enable the first light 102 to cease blinking in response to the vehicle weight exceeding the weight limit.

In some examples, the indicator system 300 enables the example LEDs 202a-j to generate one or more predetermined visual patterns. For example, as shown in the example of FIG. 5A, the indicator system 300 activates some (e.g., 202a and 202b) of the LEDs 202a-j while deactivating the other (e.g., 202c-j) of the LEDs 202a-j. Further, in the illustrated example of FIG. 5A, the indicator system 300 enables the activated ones (as represented by the texture/shading) of the LEDs 202a-j to generate the third predetermined color to indicate the vehicle weight is far below the weight limit.

According to the illustrated example of FIG. 5B, the person 400 is increasing the weight of the first vehicle 100 by lowering the object 500 into the bed 114. In particular, the indicator system 300 monitors the weight of the first vehicle 100 for changes therein and determines (e.g., via the adjustment calculator 312) adjustments for the first light 102 in response.

In some examples, as the weight of the first vehicle 100 increases and/or approaches the weight limit thereof, the indicator system 300 consecutively actives or powers adjacent LEDs 202a-j of the first light 102. For example, the indicator system 300 consecutively activates: (1) the first example LED 202a; (2) the second example LED 202b; (3) the third example LED 202c; etc., which may visually indicate to the person 400 that the weight is approaching the weight limit. Conversely, in some examples, in response to the weight of the first vehicle 100 decreasing and/or falling below the weight limit thereof, the indicator system 300 consecutively deactivates: (1) the tenth example LED 202j; (2) the ninth example LED 202i; (3) the eighth example LED 202h; etc., which may visually indicate to the person 400 that the weight is falling below the weight limit.

In some examples, as the weight of the first vehicle 100 increases and/or approaches the weight limit thereof, the indicator system 300 enables at least a portion (e.g., at least some of the LEDs 202a-j) of the first light 102 to change color (e.g., in accordance with one or more of the aforementioned predetermined color sequences in the database 306). In some examples, as the weight of the first vehicle 100 increases and/or approaches the weight limit thereof, the indicator system 300 increases (or decreases) the frequency at which the first light 102 blinks, which may visually indicate to the person 400 that weight is approaching the weight limit. In some such examples, the indicator system 300 ceases blinking (e.g., maintains an intensity of or deactivates) the first light 102 in response to the weight satisfying the threshold weight.

Further, in some examples, the indicator system 300 controls some of the example vehicle lights 102, 104, 116 different from the other lights 102, 104, 116 to visually indicate a distribution (e.g., a side-to-side distribution) of the vehicle weight. For example, the indicator system 300 detects a first load imparted on and/or associated with a first side (e.g., a left side) 502 of the first vehicle 100 and a second load imparted on and/or associated with a second side (e.g., a right side) 504 of the first vehicle 100 opposite the first side 502. In such examples, the indicator system 300 analyzes the loads and/or compares to the loads to one or more threshold loads and, in response, generates a first predetermined visual indicator via the first light 102 based on the first load and a second predetermined visual indicator (e.g., different from the first predetermined visual indicator) via the second light 104 based on the second load. In this manner, the indicator system 300 visually indicates to the person 400 that the first side 502 of the first vehicle 100 is loaded more or less than the second side 504. Further, in such examples, the indicator system 300 adjusts independently the first light 102 and second light 104 based on the respective load changes in the first load and the second load.

Additionally or alternatively, in some examples, similar to the visual indicator, the indicator system 300 controls the example horn 106 to audibly indicate to the person 400 the load status of the first vehicle 100 and/or the degree to which the first vehicle 100 is loaded below or above the weight limit thereof. For example, the indicator system 300 enables the horn 106 to activate and deactivate at a predetermined frequency.

In some such examples, as the person 400 adjusts the weight of the first vehicle 100, the indicator system 300 determines (e.g., via the adjustment calculator 312) adjustments for the horn 106 in response. For example, as the weight of the first vehicle 100 approaches the weight limit thereof, the indicator system 300 increases (or decreases) the frequency at which the horn generates sound, which may audibly indicate to the person 400 that vehicle weight is approaching the weight limit. In some such examples, the indicator system 300 ceases activating and deactivating (e.g., maintains a volume of or deactivates) the horn 106 in response to the vehicle weight exceeding the weight limit, which may audibly indicate to the person 400 that the first vehicle 100 improperly loaded.

While the example of FIGS. 5A and 5B depict light control in association with load detection and/or monitoring, in some examples, the indicator system 300 similarly controls the example light(s) 102, 104, 116 in association with detecting and/or monitoring one or more other parameters of the first vehicle 100 and visually indicating one or more respective statuses to the person 400, as previously disclosed.

In some examples, the indicator system 300 of the illustrated example controls the light(s) 102, 104, 116 based on data from the sensor(s) 110 corresponding to a position of one or more windows (e.g., the example window 124) of the first vehicle 100 to visually indicate the position to the person 400. In such examples, the indicator system 300 controls at least some of the lights 102, 104, 116 differently from the other lights 102, 104, 116 to indicate which ones of the window(s) of the first vehicle 100 is/are open, closed, and/or a degree to which each window is open. For example, the indicator system 300 generates a first predetermined visual indicator via the first light 102 to visually indicate a first position of a vehicle window proximate thereto, a second predetermined visual indicator (e.g., different from the first predetermined visual indicator) via the second light 104 to visually indicate a second position (e.g., different from the first position) of a second window proximate thereto, etc. Further, in such examples, the indicator system 300 adjusts independently the first light 102, the second light 104, and/or one or more other vehicle lights based on the respective position changes in the vehicle windows. In this manner, the indicator system 300 enables the person 400 to accurately adjust one or more windows of the first vehicle 100 remotely (e.g., via an electronic key or fob communicatively coupled to the controller 112 and/or the first vehicle 100) and/or from a location external to the first vehicle 100.

In some examples, the indicator system 300 of the illustrated example controls the light(s) 102, 104, 116 based on data from the sensor(s) 110 corresponding to a position and/or engagement of one or more locks (e.g., the example lock 128) of the first vehicle 100 to visually indicate the same to the person 400. In such examples, the indicator system 300 controls at least some of the lights 102, 104, 116 differently from the other lights 102, 104, 116 to indicate which ones of the lock(s) of the first vehicle 100 is/are locked or unlocked.

In some examples, the indicator system 300 of the illustrated example controls the light(s) 102, 104, 116 based on data from the sensor(s) 110 corresponding to a fuel level of the first vehicle 100 to visually indicate the same to the person 400. In particular, in such examples, the indicator system 300 calculates and/or determines an amount of a fuel (e.g., gasoline) in the fuel tank of the first vehicle 100 and compares the amount of fuel to a threshold fuel level (e.g., a value corresponding to a proportion of a capacity of the fuel tank) and, in response, generates a predetermined visual indicator via the light(s) 102, 104, 116. Further, the indicator system 300 enables the light(s) 102, 104, 116 to change between predetermined visual indicators in response to detected changes in the fuel level. In this manner, the indicator system 300 visually assists the person 400 in filling the fuel tank of the first vehicle 100 to a certain level, for example, that may be associated with a rented vehicle and/or required by a vehicle rental company to avoid additional costs and/or fees. In some such examples, the indicator system 300 may implement such control in response to one or more of a setting thereof being activated (e.g., via input to the mobile device 120) by the person, detected changes in the fuel level, and/or the fuel door 130 being open. That is, the indicator system 300 can detect and/or determine when the person 400 is fueling the first vehicle 100 and/or when fuel door 103 is open based on sensor data.

Accordingly, in some examples, the indicator system 300 of the illustrated example controls the light(s) 102, 104, 116 based on data from the sensor(s) 110 corresponding to a position and/or state associated with the fuel door 130 of the first vehicle 100 to visually indicate the same to the person 400. In particular, the indicator system 300 calculates and/or determines a fluid pressure in the fuel tank of the first vehicle 100 and compares the fluid pressure to a threshold fluid pressure indicative of the state of the fuel door and, in response, enables the light(s) 102, 104, 116 to generate a predetermined visual indicator to indicate to the person 400 whether the fuel door 130 is open or closed.

In some examples, the indicator system 300 of the illustrated example controls the light(s) 102, 104, 116 based on data received from the sensor(s) 110 corresponding to a fluid pressure of one or more tires (e.g., the example tire 132) of the first vehicle 100 to visually indicate the pressure of each tire to the person 400. In particular, the indicator system 300 enables the light(s) 102, 104, 116 to generate a predetermined visual indicator based on a magnitude of the fluid pressure relative to a magnitude of a fluid pressure threshold. In such examples, the indicator system 300 can control at least some of the lights 102, 104, 116 differently from the other lights 102, 104, 116 to indicate which ones of the tires of the first vehicle 100 are sufficiently filled or inflated and/or a degree to which each tire is inflated. For example, the indicator system 300 generates a first predetermined visual indicator via the first light 102 to visually indicate a first fluid pressure of the first example tire 132 proximate thereto, a second predetermined visual indicator (e.g., different from the first predetermined visual indicator) via the second light 104 to visually indicate a second fluid pressure (e.g., different from the first position) of a second tire of the first vehicle 100 proximate thereto, etc. Further, in such examples, the indicator system 300 adjusts independently the first light 102, the second light 104, and/or one or more other vehicle lights based on the respective fluid pressure changes in the tires of the first vehicle 100. In this manner, the indicator system 300 enables the person 400 to accurately adjust the pressure of one or more vehicle tires, for example, without checking a tire pressure using a tool (e.g., a pressure gauge).

Further, in such examples, the indicator system 300 can determine when a tire of the first vehicle 100 is being filled by the person 400 for example, based on detected fluid pressure changes in a vehicle tire. In response to determining that the person 400 is adjusting a pressure of at least one tire of the first vehicle 100, the indicator system 300 may implement control of the light(s) 102, 104, 116 accordingly to inform the person 400 of the tire pressure(s).

In some examples, the indicator system 300 of the illustrated example controls the light(s) 102, 104, 116 based on data received from the sensor(s) 110 corresponding to one or more of electrical power, voltage, and/or current associated with the battery and/or the generator of the first vehicle 100 to visually indicate the same to the person 400. In particular, the indicator system 300 enables the light(s) 102, 104, 116 to generate a predetermined visual indicator based on a magnitude of one or more of the power, the voltage, and/or the current relative to a magnitude of one or more respective thresholds (e.g., a threshold power, a threshold voltage, and/or a threshold current). Further, in such examples, the indicator system 300 changes or adjusts a visual characteristic of the light(s) 102, 104, 116 in response to detected changes in one or more of the power, the voltage, and/or the current.

In some examples, the indicator system 300 of the illustrated example controls the light(s) 102, 104, 116 based on data received from the sensor(s) 110 corresponding to one or more temperatures (e.g., a temperature of a cabin inside the first vehicle 100, a temperature of the engine of the first vehicle 100, a temperature of oil in the engine and/or the first vehicle 100, etc.) associated with the first vehicle 100 to visually indicate the same to the person 400. In particular, the indicator system 300 enables the light(s) 102, 104, 116 to generate a predetermined visual indicator based on a magnitude of the temperature relative to a magnitude of a threshold temperature. Further, in such examples, the indicator system 300 changes or adjusts a visual characteristic of the light(s) 102, 104, 116 in response to detected changes in the temperature.

In such examples, the indicator system 300 enables the person 400 to visually determine (e.g., from a location external to the first vehicle 100) whether a temperature in the first vehicle 100 (e.g., a temperature of the vehicle engine and/or the vehicle cabin) is sufficient and/or desirable to the person 400. In some examples, the indicator system 300 implements such control of the light(s) 102, 104, 116 in response to the person 400 starting the first vehicle 100 from a remote location, for example, via an electronic key or fob communicatively coupled to the indicator system 300. Similarly, in such examples, the indicator system 300 enables the person to visually determine whether a temperature of the oil of the first vehicle 100 is sufficiently cool before replacing or changing the oil.

In some examples, the indicator system 300 of the illustrated example controls the light(s) 102, 104, 116 based on data received from the sensor(s) 110 corresponding to a distance between the person 400 (and/or one or more other persons (e.g., a pedestrian)) and the first vehicle 100 to visually indicate the same to the person 400. For example, the indicator system 300 receives data from the sensor(s) 110 (e.g., a proximity sensor) and, in some examples, calculates and/or determines the distance based on one or more related equations, algorithms, and/or methods or techniques. In particular, the indicator system 300 enables the light(s) 102, 104, 116 to generate a predetermined visual indicator based on a magnitude of the distance. Further, in such examples, the indicator system 300 changes or adjusts a visual characteristic of the light(s) 102, 104, 116 in response to detected changes in the distance. In this manner, the indicator system 300 visually informs the person 400 (and/or one or more other persons) that the first vehicle 100 is approaching (e.g., when driving autonomously and/or in reverse) and/or of a relative proximity of the first vehicle 100. In such examples, the indicator system 300 may implement such control of the light(s) 102, 104, 116 in response to the first vehicle 100 being in a certain driving mode (e.g., an autonomous driving mode) and/or a certain gear (e.g., reverse).

Further, in some such examples, the indicator system 300 controls the light(s) 102, 104, 116 in this manner in response to the first vehicle 100 being parked and/or a vehicle alarm system being active. Accordingly, in such examples, the indicator system 300 may visually warn and/or deter an undesired person from approaching or entering the first vehicle 100 by adjusting the characteristic of the light(s) 102, 104, 116 based on a distance between the undesired person and the first vehicle 100.

In some examples, the indicator system 300 of the illustrated example controls the light(s) 102, 104, 116 based on data received from the sensor(s) 110 corresponding to a volume or sound intensity in and/or near the first vehicle 100 to visually indicate the same to the person 400. For example, the indicator system 300 detects and/or measures the sound intensity via the sensor(s) 110 (e.g., a microphone) and/or via an electrical or audio signal (e.g., generated by an electronic device (e.g., a radio) in the first vehicle 100) provided to the indicator system 300. In particular, the indicator system 300 enables the light(s) 102, 104, 116 to generate a predetermined visual indicator based on a magnitude of the sound intensity and/or the audio signal. Further, in such examples, the indicator system 300 changes or adjusts a visual characteristic of the light(s) 102, 104, 116 in response to detected changes in the sound intensity and/or the audio signal. In this manner, the indicator system 300 visually informs the person 400 (and/or one or more other persons) of changes in sound intensity, which may be entertaining and/or desirable to the person 400 (e.g., when tailgating and/or when the first vehicle 100 is parked).

Additionally or alternatively, in some examples, the indicator system 300 analyzes sensor data and controls the light(s) 102, 104, 116 of the first vehicle 100 in accordance with instructions provided by one or more users such as, for example, software and/or application developers. In such examples, the instructions may be stored in and/or installed on the example database 306 for execution by the indicator system 300.

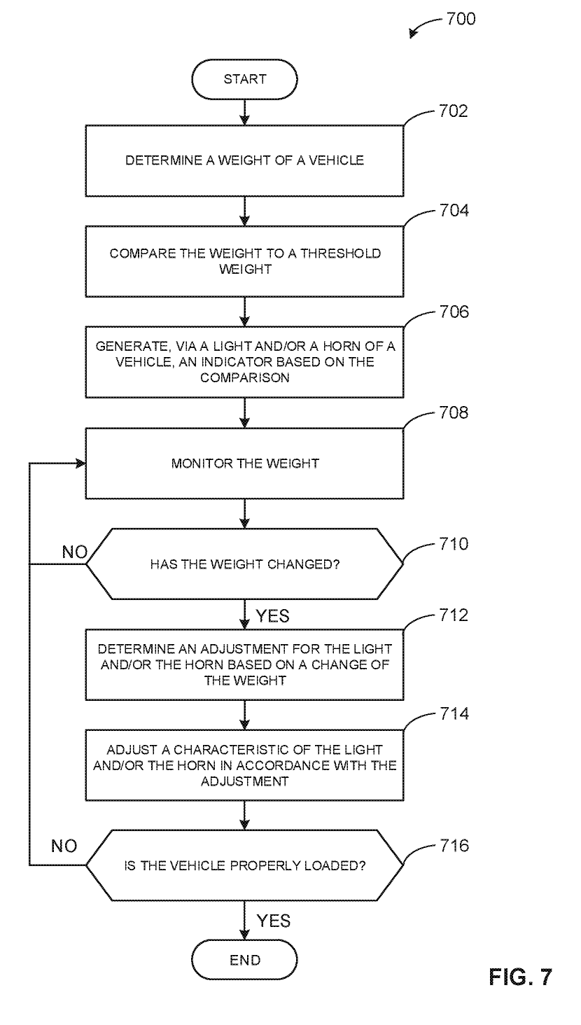

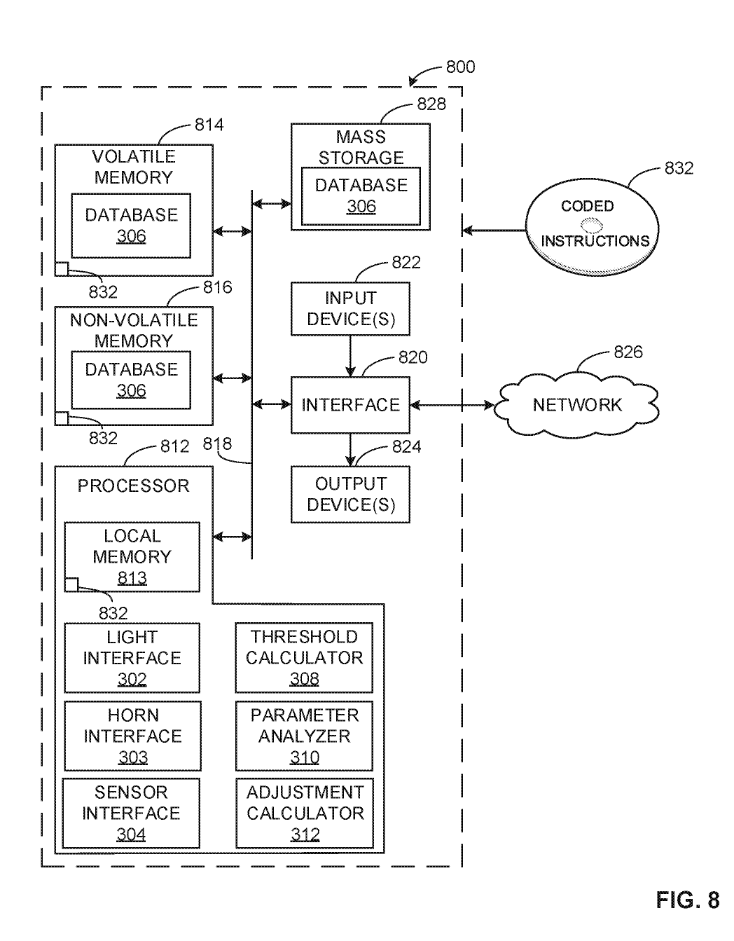

A flowchart representative of example hardware logic or machine readable instructions for implementing the example indicator system 300 is shown in FIGS. 6 and 7. The machine readable instructions may be a program or portion of a program for execution by a processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIGS. 6 and 7, many other methods of implementing the example indicator system 300 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 6 and 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

FIG. 6 is a flow diagram of an example method 600 that may be executed to implement the example indicator system 300 of FIG. 3. The example method 600 of FIG. 6 can be implemented in any of the example first vehicle 100 of FIGS. 1, 4A, 4B, 5A, and 5B, the example fourth light 200 of FIG. 2, and/or the example indicator system 300 of FIG. 3.

The example method 600 begins by determining a load imparted on a hitch (block 602). In some examples, the indicator system 300 of FIG. 3 determines (e.g., via the sensor interface 304) a load imparted on the example hitch 108 by the trailer tongue 406 based on data received from the sensor(s) 110.

The example method 600 also includes comparing the load to a threshold load (block 604). In some examples, the indicator system 300 of FIG. 3 compares (e.g., via the parameter analyzer 310) the load imparted on the example hitch 108 to a threshold load (e.g., determined via the threshold calculator 308).

The example method 600 also includes generating, via a light and/or a horn of a vehicle, an indicator based on the comparison (block 606). In some examples, the indicator system 300 of FIG. 3 controls (e.g., via the light interface 302) one or more of the example first light 102, the example second light 104, the example third light 116, and/or the example fourth light 200 based on the comparison at block 604. In particular, the indicator system 300 enables the light(s) 102, 104, 116, 200 to generate a predetermined visual indicator corresponding to a load status (e.g., properly or improperly loaded) of the example trailer 402 and/or a degree to which the trailer 402 is improperly loaded.

In some examples, the indicator system 300 controls (e.g., via the horn interface 303) the example horn 106 based on the comparison at block 604. In such examples, the indicator system 300 enables the horn 106 to generate a predetermined audible indicator corresponding to the load status of the trailer 402 and/or the degree to which the trailer 402 is improperly loaded.

The example method 600 also includes monitoring the load (block 608). In some examples, the indicator system 300 of FIG. 3 monitors (e.g., via the sensor interface 304) the load imparted on the hitch 108 based on data received from the sensor(s) 110.

The example method 600 also includes determining whether the load has changed (block 610). In some examples, the indicator system 300 of FIG. 3 determines (e.g., via the parameter analyzer 310) whether the load imparted on the hitch 108 has changed. In some examples, if the indicator system 300 determines that the load has changed (block 610: YES), control of the example method 600 proceeds to block 612. Otherwise, if the indicator system 300 determines that the load has not changed (block 610: NO), control of the example method 600 returns to block 608.

The example method 600 also includes determining an adjustment for the light and/or the horn based on a change of the load (block 612). In some examples, the indicator system 300 of FIG. 3 determines (e.g., via the adjustment calculator 312) an adjustment for one or more of the lights 102, 104, 116, 200 based on a change in the load. In particular, the adjustment includes a change in a visual characteristic of the light(s) 102, 104, 116, 200 based on the change in the load.

In some examples, the indicator system 300 of FIG. 3 determines (e.g., via the adjustment calculator 312) an adjustment for the horn 106 based on a change in the load. In particular, the adjustment includes a change in an audible characteristic of the horn 106 based on the change in the load.

The example method 600 also includes adjusting a characteristic of the light and/or the horn in accordance with the adjustment (block 614). In some examples, the indicator system 300 of FIG. 3 changes or adjusts (e.g., via the light interface 302) a visual characteristic of one or more of the lights 102, 104, 116, 200 in accordance with the adjustment at block 612. In some examples, the indicator system 300 of FIG. 3 changes or adjusts (e.g., via the horn interface 303) an audible characteristic of the horn 106 in accordance with the adjustment at block 612.

The example method 600 also includes determining whether the trailer is properly loaded (block 616). In some examples, the indicator system 300 of FIG. 3 determines whether the example trailer 402 is properly loaded. If the indicator system 300 determines the trailer 402 is properly loaded (block 616: YES), the example method 600 ends. Otherwise, in some examples, if the indicator system 300 determines the trailer 402 is not properly loaded (block 616: NO), control of the example method 600 returns to block 608.

FIG. 7 is a flow diagram of an example method 700 that may be executed to implement the example indicator system 300 of FIG. 3. The example method 700 of FIG. 7 can be implemented in any of the example first vehicle 100 of FIGS. 1, 4A, 4B, 5A, and 5B, the example fourth light 200 of FIG. 2, and/or the example indicator system 300 of FIG. 3.

The example method 700 begins by determining a weight of a vehicle (block 702). In some examples, the indicator system 300 of FIG. 3 determines (e.g., via the sensor interface 304) a weight of the example first vehicle 100 based on data received from the sensor(s) 110.

The example method 700 also includes comparing the weight to a threshold weight (block 704). In some examples, the indicator system 300 of FIG. 3 compares (e.g., via the parameter analyzer 310) the weight of the first vehicle 100 to one or more threshold weights (e.g., determined via the threshold calculator 308).

The example method 700 also includes generating, via a light and/or a horn of the vehicle, an indicator based on the comparison (block 706). In some examples, the indicator system 300 of FIG. 3 controls (e.g., via the light interface 302) one or more of the example first light 102, the example second light 104, the example third light 116, and/or the example fourth light 200 based on the comparison at block 704. In particular, the indicator system 300 enables the light(s) 102, 104, 116, 200 to generate a predetermined visual indicator corresponding to a load status (e.g., properly or improperly loaded) of the first vehicle 100 and/or a degree to which the first vehicle 100 is loaded below or above a weight limit thereof.

In some examples, the indicator system 300 controls (e.g., via the horn interface 303) the example horn 106 based on the comparison at block 704. In such examples, the indicator system 300 enables the horn 106 to generate a predetermined audible indicator corresponding to the load status of the first vehicle 100 and/or the degree to which the first vehicle 100 is loaded below or above the weight limit.

The example method 700 also includes monitoring the weight (block 708). In some examples, the indicator system 300 of FIG. 3 monitors (e.g., via the sensor interface 304) the weight of the first vehicle 100 based on data received from the sensor(s) 110.

The example method 700 also includes determining whether the weight has changed (block 710). In some examples, the indicator system 300 of FIG. 3 determines (e.g., via the parameter analyzer 310) whether the weight of the first vehicle 100 has changed. In some examples, if the indicator system 300 determines that the vehicle weight has changed (block 710: YES), control of the example method 700 proceeds to block 712. Otherwise, if the indicator system 300 determines that the load has not changed (block 710: NO), control of the example method 700 returns to block 708.

The example method 700 also includes determining an adjustment for the light and/or the horn based on a change in the weight (block 712). In some examples, the indicator system 300 of FIG. 3 determines (e.g., via the adjustment calculator 312) an adjustment for one or more of the lights 102, 104, 116, 200 based on a change in the weight of the first vehicle 100. In particular, the adjustment includes changing a visual characteristic of the light(s) 102, 104, 116, 200 based on the change in the weight.

In some examples, the indicator system 300 of FIG. 3 determines (e.g., via the adjustment calculator 312) an adjustment for the horn 106 based on the change in the weight of the first vehicle 100. In particular, the adjustment includes changing an audible characteristic of the horn 106 based on the change in the weight.

The example method 700 also includes adjusting a characteristic of the light and/or the horn in accordance with the adjustment (block 714). In some examples, the indicator system 300 of FIG. 3 changes or adjusts (e.g., via the light interface 302) a visual characteristic of one or more of the lights 102, 104, 116, 200 in accordance with the adjustment at block 712. In some examples, the indicator system 300 of FIG. 3 changes or adjusts (e.g., via the horn interface 303) an audible characteristic of the horn 106 in accordance with the adjustment at block 712.

The example method 700 also includes determining whether the vehicle is properly loaded (block 716). In some examples, the indicator system 300 of FIG. 3 determines whether the example first vehicle 100 is properly loaded. If the indicator system 300 determines the first vehicle 100 is properly loaded (block 716: YES), the example method 700 ends. Otherwise, in some examples, if the indicator system 300 determines the first vehicle 100 is not properly loaded (block 716: NO), control of the example method 700 returns to block 708.

FIG. 8 is a block diagram of an example processor platform 800 structured to execute the instructions to carry out the example methods 600, 700 of FIGS. 6 and 8 and/or, more generally, to implement the example indicator system 300 of FIG. 3. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example light interface 302, the example horn interface 303, the example sensor interface 304, the example database 306, the example threshold calculator 308, the example parameter analyzer 310, and the example adjustment calculator 312.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 6 and 7 may be stored in the mass storage device 828, in the volatile memory 814, in the non-volatile memory 816, and/or on a removable non-transitory computer readable storage medium such as a CD or DVD.

From the foregoing, it will be appreciated that indicator apparatus and related methods for use with vehicles have been disclosed that assist a person in loading a vehicle and/or a trailer. Examples disclosed herein provide visual and/or audible indicators to the person during a loading event to ensure the vehicle and/or the trailer is properly loaded. Some disclosed examples assist a person in visually determining and/or monitoring one or more other vehicle statuses.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a controller configured to:
determine a load imparted on a hitch via a sensor, the hitch to be coupled between a vehicle and a trailer;
compare the load to a threshold load, the threshold load based on a weight of the trailer; and
control an exterior light of the vehicle based on the comparison to visually indicate a load status of the trailer.

2. The apparatus of claim 1, wherein the controller is to control the exterior light to blink at a predetermined frequency based on the comparison.

3. The apparatus of claim 2, wherein the controller is to change the frequency based on a change in the load.

4. The apparatus of claim 2, wherein the controller is to cease blinking the exterior light in response to the load satisfying the threshold load.

5. The apparatus of claim 1, wherein the controller is to control a color of the exterior light based on the comparison.

6. The apparatus of claim 1, wherein the exterior light is a taillight.

7. The apparatus of claim 1, wherein the exterior light includes light sources, and wherein the controller is to generate, via the light sources, a predetermined visual pattern based on the comparison.

8. The apparatus of claim 1, wherein the controller is to control a horn of the vehicle based on the comparison to audibly indicate the load status of the trailer.

9. An apparatus comprising:
a controller configured to:
determine a weight of a vehicle via a sensor;
compare the weight to a threshold weight, the threshold weight based on a capacity of the vehicle; and
control an exterior light of the vehicle based on the comparison to visually indicate a load status of the vehicle.

10. The apparatus of claim 9, wherein the controller is to control a color of the exterior light based on the comparison.

11. The apparatus of claim 10, wherein, based on a change in the weight, the controller is to change the color in accordance with a predetermined color sequence.

12. The apparatus of claim 9, wherein the controller is to blink the exterior light in response to the weight exceeding the threshold weight.

13. The apparatus of claim 9, wherein the exterior light includes light sources, and wherein the controller is to generate, via the lights sources, a predetermined visual pattern based on the comparison.

14. The apparatus of claim 13, wherein the controller is to consecutively activate or deactivate the light sources based on a change in the weight.

15. The apparatus of claim 13, wherein, in response to the weight exceeding the threshold weight, the controller is to blink some of the light sources while maintaining brightness of the other of the light sources.

16. The apparatus of claim 9, wherein the exterior light of the vehicle is at least one of a taillight, a headlight, a third brake light, or a side marker.

17. The apparatus of claim 9, wherein the controller is to control a horn of the vehicle based on the comparison to audibly indicate the status of the vehicle.

18. An apparatus comprising:
a controller configured to:
determine, via a sensor, a load associated with a vehicle during a loading event;
compare the load to a threshold load; and
control an external light or a horn of the vehicle based on the comparison to indicate a load status of the vehicle.

19. The apparatus of claim 18, wherein the controller is to activate and deactivate, at a predetermined frequency, the external light or the horn based on the comparison.

20. The apparatus of claim 19, wherein the controller is to change the frequency based on a change in the load.

21. An apparatus comprising:
a controller configured to:
determine, via a sensor, a parameter associated with a vehicle;
compare the parameter to a threshold parameter; and
control an exterior light of the vehicle based on the comparison to indicate a status of the vehicle.
